(19) United States
(12) Patent Application Publication
(10) Pub. No.: US 2009/0319416 A1
(43) Pub. Date: Dec. 24, 2009

(54) METHOD OF STRUCTURING REAL ESTATE ASSETS

(75) Inventors: Brian Marek, Duncanville, TX (US); Charles E. Greef, Dallas, TX (US); Peter G. Weinstock, Dallas, TX (US); Jeff Blair, Dallas, TX (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Hunton & Williams LLP, Richmond, VA (US)

(21) Appl. No.: 12/144,212

(22) Filed: Jun. 23, 2008

(51) Int. Cl. G06Q 40/00

(52) U.S. Cl. 705/37; 705/39

(57) ABSTRACT

An system for and method of divesting real property is presented. The system and method improve upon prior art techniques by including one or more of the following advantages: the gain may be immediately booked, there may be no capitalization requirements as there may be on a financing lease, and the gain may avoid Federal income taxation and capital gains taxation.

### FIELD OF THE INVENTION

The present invention generally relates to a system for and method of divesting real property.

### BACKGROUND OF THE INVENTION

A company may enter into an arrangement in which it first sells, and then leases back, a place of business of the company and its underlying real property. The second transaction is sometimes known as a “leaseback.” Thus, in a sale and leaseback arrangement, a company may sell its facilities and real property on which such facilities are located to a third party, and then lease the facilities and real property back from the third party. Typically, the company will continue using its place of business, leased from the third party.

Accounting regulatory agencies sometimes treat leasebacks as so-called “financing leases.” Under generally accepted accounting principles, “A lease that transfers substantially all of the benefits and risks incident to the ownership of property may be accounted for as the acquisition of an asset and the incurrence of an obligation by the lessee and as a sale or financing by the lessor. In a lease that transfers substantially all of the benefits and risks of ownership, the economic effect on the parties is similar, in many respects, to that of an installment purchase.” See Statement of Financial Accounting Standards No. 13 (promulgated by the Financial Accounting Standards Board).

Financing leases have certain disadvantages. First, the lessee may be required to capitalize the lease. That is, the lessee may be required to account for, on its balance sheets and financial statements, the sale price of the real property as an asset and the lease as a liability. Increasing both assets and liabilities is generally disfavored, because, for example, it can dilute its ratio of earnings to assets for the affected company. For regulated financial institutions, transactions that increase both assets and liabilities will decrease the ratio of capital to assets, which may be required to be maintained at certain minimum ratios. Second, the lessee may be required to realize the gain from the sale of the property over the term of the lease instead of at the time of the sale. That is, the company that sells the property may be prevented from immediately recognizing the gain (i.e., sale price minus book value) from the sale of the property. Instead, the company may be required to account for the gain in increments over the term of the lease. This situation is disfavored because such an income stream is generally not reflected on a company's balance sheet or financial statement. Thus, a potential investor doing due diligence on a such a company may not be aware that the company expects to periodically realize additional income from the sale of those assets. Note that some embodiments of the present invention may avoid one of these named disadvantages. Other embodiments may avoid both disadvantages.

### BRIEF DESCRIPTION OF THE FIGURES

FIG. 1 is a flowchart depicting a method of divesting real property according to an embodiment of the present invention.

FIG. 2 is a flowchart depicting a method of divesting real property according to an embodiment of the present invention.

### DETAILED DESCRIPTION OF CERTAIN EMBODIMENTS OF THE INVENTION

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

Some embodiments of the present invention allow a company to divest itself of real property while avoiding certain unwanted tax consequences. More particularly, some embodiments of the present invention allow a company to divest itself of real property without having to pay income or capital gains tax on any difference between the sale price and the book value of the real property.

Some embodiments of the present invention allow a company to realize income resulting from a real estate divestiture all at once, as opposed to over a period of time as would be required with some sale and leaseback transactions. This is advantageous because the gain from the transaction may immediately appear on the company's public records, such as a balance sheet or financial statement, and be apparent to any current or potential investor.

Some embodiments of the present invention allow a company to divest itself of real property without having to comply with the capitalization requirements of a financing lease. That is, some embodiments allow a company to divest itself of real property and immediately realize the associated gain without having to account for the market value of the property as an asset and any lease as a liability.

Some embodiments of the present invention have the advantage of reducing a company's total booked assets without affecting the company's use of the divested real property. That is, certain embodiments of the present invention allow a company to improve its earnings to assets ratio by divesting itself of real estate without relinquishing its use of such property.

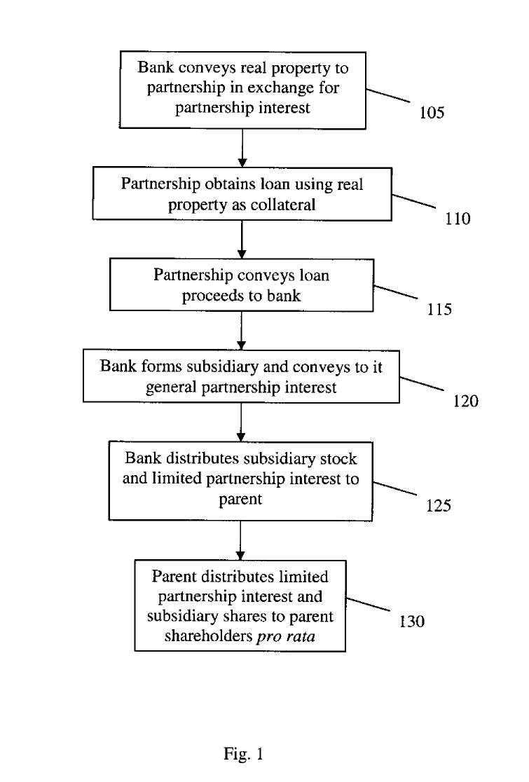

FIG. 1 is a flowchart depicting a method of divesting real property according to an embodiment of the present invention. The divesting company may be, by way of non-limiting example, a bank, and the real property may be, by way of non-limiting example, a property on which the divesting company maintains a place of business. Throughout this disclosure, the term “bank” will be used to identify the divesting company, however, such usage is not meant to limit embodiments of the invention to divestitures by banks only. That is, any company or other entity may practice embodiments of the present invention. The method begins with the bank forming a second company, which may be, by way of non-limiting example, a limited partnership, a limited liability company, or any other tax pass-through entity. This second company will be referred to herein as the “partnership,” however, this term is for illustrative purposes only and is not meant to limit embodiments of the present invention to using only partnerships in the capacity of the second company.

At step 105, the bank conveys its real property to be divested to the partnership in exchange for a general partnership interest and all limited partnership interests. (In embodiments in which the tax pass-through entity is a limited liability company, general shares may be used instead of the general partnership interests and limited shares may be used in place of the limited partnership interests. For clarity of exposition, the terms “general partnership interests” and “limited partnership interests” are used herein without any intent to limit the invention to the same.) That is, the partnership receives the real property, and the bank receives a general partnership interest and all of the limited partnership interests. The partnership may be one or both of formed by the bank and wholly owned by the bank.

At step 110, the partnership obtains a loan from a third-party bank using the real property as collateral. In some embodiments, the amount of the loan is the entire market value of the real property. Thus, in some embodiments, the partnership obtains the market value of the real property by collateralizing a loan with the real property. Thus, at this stage, the partnership retains ownership of the real property.

At step 115, the partnership distributes the loan proceeds to the bank. This money may be in the form of cash. The bank may immediately book the loan proceeds as an asset in its balance sheet and financial statement. That is, the bank may not be required to account for the loan proceeds in periodic increments, as may be required under a financing lease. Note further that the loan proceeds received from the partnership, minus the book value of the real property and any Federal income tax that may be applicable, may be treated as Tier 1 or regulatory capital under applicable banking regulations.

After step 115, the partnership has the real property that the bank formerly owned as an asset and has the amount due on the loan as a liability. Thus, in embodiments in which the loan amount is equal to the market value of the property, the net worth of the partnership is zero. Accordingly, the fair market value of the limited partnership interests may be substantially equal to zero dollars.

At step 120, the bank forms a wholly owned subsidiary. The bank then conveys its general partnership interests to the subsidiary. The subsidiary will be referred to herein as the “general partnership interest holding company.” Thus, after stage 120, the bank no longer owns the partnership's general partnership interest, but the bank retains its limited partnership interests. In some embodiments, persons who serve as officers or directors of the bank also serve as officers and directors of the general partnership interest holding company. In some embodiments, step 120 is omitted and the bank retains the general partnership interest that it obtained at step 105. In those embodiments, the bank maintains some control over the real property. As general partner, the bank may continue to be able to protect the bank's interests in how the real property is developed.

At step 125, the bank distributes its limited partnership interest in the partnership to the bank's parent company. This distribution may be considered as an in-kind (rather than cash) dividend, which may require prior approval by applicable bank regulatory agencies. In embodiments that include step 120, the bank also conveys to the bank's parent company the bank's shares in the general partnership interest holding company. Thus, after step 125, the bank's parent company owns the entire limited partnership interest in the partnership and may also own all shares in the general partnership interest holding company, which owns the partnership's entire general partnership interest.

In some embodiments, the bank is not taxed on the loan proceeds received from the partnership. That is, in some embodiments, the loan proceeds are not treated as income or capital gains. Accordingly, in some embodiments, the bank does pay tax on the loan proceeds. In other embodiments, the bank may recognize and be taxed on a gain of the difference between the loan proceeds and the real property's book value, reduced by the amount of gain allocable to the retained general partnership interest (if any) upon distribution of the limited partnership interests to the bank's parent company.

At step 130, the bank's parent company distributes the limited partnership interests in the partnership to the shareholders of the bank's parent company. In embodiments that include step 120, the bank's parent company also distributes the shares in the general partnership interest holding company to the shareholders of the bank's parent company. The bank's parent company distributes its partnership interests (including the shares of the general partnership interest holding company, if applicable), to its shareholders pro rata. That is, the bank's parent company distributes its partnership interests to a given shareholder in proportion to that shareholder's holdings in the bank's parent company.

In some embodiments, restrictions are placed on transfers of the limited partnership interests and the shares in the general partnership interest holding company. Such restrictions may require that any transfer of the limited partnership interests and the shares in the general partnership interest holding company be accompanied by a like transfer of the parent company's common stock. That is, the parent company's shareholders may be required to treat the limited partnership interests, the shares in the general partnership interest holding company, and the shares in the bank's parent company that correspond, pro rata, to the limited partnership interests and the shares in the general partnership interest holding company as a single financial instrument for the purpose of any transfer. In some embodiments, the partnership's partnership agreement includes restrictions on transfer of the limited partnership interests in order to avoid having the IRS consider the partnership a “publicly traded partnership) as defined in Section 7704 of the Internal Revenue Code of 1986, as amended. In embodiments in which the partnership interests are tied to the shares in the bank's parent company, transfer restrictions may also be placed on the parent company's shares. Such restriction may be in the form of a contract that buyers of the parent company's shares must execute before obtaining such shares.

The relevant regulatory agencies may treat the distribution of the limited partnership interests and the shares in the general partnership interest holding company (or the general partnership interest itself) as dividends in kind rather than as cash dividends. As discussed above in reference to step 115, the limited partnership interests are essentially worth zero. Those two facts mean that the shareholders in the bank's parent company will be treated as having received a dividend in an amount equal to the fair market value of the received partnership interest, i.e., zero. The tax consequences to the shareholders of the bank's parent company are thus de minimus. Note that the shareholders in the bank's parent company do not realize any tax consequences until they sell or otherwise divest themselves of their partnership interests.

In some embodiments, the shareholders of the bank's parent company become limited partners in the partnership. In such embodiments, the parent company shareholders may be required to execute a document (e.g., a joinder) evidencing that they accept the terms of the partnership's partnership agreement. Distributing the limited partnership interests to a shareholder may be conditioned upon receipt of such a document executed by the shareholder. If a particular parent company shareholder fails to execute such a document, the parent company may (i) cancel the limited partnership interest that would have gone to that shareholder, thereby increasing pro rata the limited partnership interests of all other shareholders who executed and submitted such documents, or (ii) convert the limited partnership interest to an assignment of economic interest, which would entitle the shareholder to his or her pro rata share of the economic limited partnership interest, but would not entitle them to rights as a partner. The latter approach would allow all shareholders to retain their pro rata interest even if they fail to become partners.

In general, the distribution of limited partnership interests by a company to its shareholders is not a transaction that requires the filing and distribution of a registration statement with the Securities and Exchange Commission (“SEC”), provided that the shareholders receive the limited partnership interests in exchange for no consideration. In some embodiments, the bank's parent company's shareholders are not expected to receive anything other than their pro rated portion of the limited partnership interests in the partnership and are expected to receive these interests in exchange for no consideration. Therefore, in such embodiments, the distribution of these limited partnership interests may not be treated as the offering of a security requiring the filing of a registration statement with the SEC.

Thus, after step 130, ownership of the partnership is distributed to the shareholders of the bank's parent company. Accordingly, the bank neither owns nor directly controls the partnership. The bank is therefore not required to consolidate the partnership into the bank's balance sheet or financial statement. Note that, more generally, neither the bank nor the bank's parent company retain any interest in the partnership or the general partnership interest holding company.

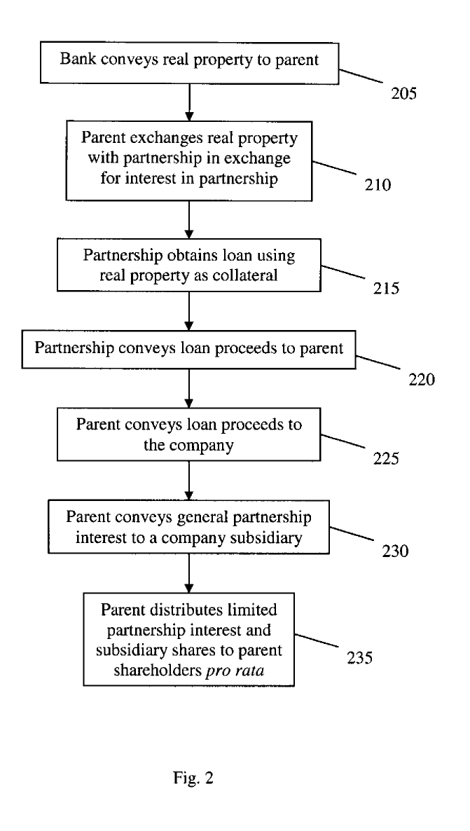

FIG. 2 is a flowchart depicting a method of divesting real property according to an embodiment of the present invention. At step 205, the bank conveys its real property to be divested to its parent company. This conveyance may be considered as an in-kind (rather than cash) dividend, which may require prior approval by applicable bank regulatory agencies. The parent company then forms a tax pass-through entity, which will be referred to herein as a “partnership” for convenience, even though other company types may be used, such as limited liability companies. At step 210, the parent company conveys the real property to the partnership in exchange for a general partnership interest and the limited partnership interests of the partnership. (In embodiments in which the tax pass-through entity is a limited liability company instead of a partnership, general shares may be used in place of the general partnership interests and limited shares may be used in place of the limited partnership interests. For clarity of exposition, the terms “general partnership interests” and “limited partnership interests” may be used herein without limitation.) That is, the partnership receives the real property, and the bank's parent company receives a general partnership interest and all of the limited partnership interests.

At step 215, the partnership obtains a loan from a third-party bank using the real property as collateral. In some embodiments, the amount of the loan is the entire market value of the real property. Thus, in some embodiments, the partnership obtains the market value of the real property by collateralizing a loan with the real property. At this stage, the partnership retains ownership of the real property.

At step 220, the partnership conveys the loan proceeds to the bank's parent company, and at stage 225, the bank's parent company conveys the proceeds to the bank. Note that after step 220, the partnership has the real property that the bank formerly owned as an asset and has the amount due on the loan as a liability. Thus, in embodiments in which the loan amount is equal to the market value of the property, the net worth of the partnership is zero after step 220. Accordingly, the fair market value of the limited partnership interests may be substantially equal to zero dollars.

The bank may immediately book the loan proceeds as an asset on its balance sheet and financial statement. That is, the bank may not be required to account for the loan proceeds in periodic increments, as may be required under a financing lease. Note further that the loan proceeds received from the partnership, minus the book value of the real property and any Federal income tax that may be applicable, may be treated as Tier 1 or regulatory capital under applicable banking regulations.

In some embodiments, the bank is not taxed on the loan proceeds received from the bank's parent company. That is, in some embodiments, the loan proceeds are not treated as income or capital gains. Accordingly, in some embodiments, the bank does pay tax on the loan proceeds. In other embodiments, the bank may recognize and be taxed on a gain of the difference between the loan proceeds and the real property's book value, reduced by the amount of gain allocable to the retained general partnership interest (if any) upon distribution of the limited partnership interests to the bank's parent company.

At step 230, the bank forms a wholly owned subsidiary. The bank's parent company then conveys its general partnership interests to the subsidiary. The subsidiary will be referred to herein as the “general partnership interest holding company.” Thus, after stage 230, the bank's parent company no longer owns the partnership's general partnership interest, but it does retain its limited partnership interests. In some embodiments, persons who serve as officers or directors of the bank also serve as officers and directors of the general partnership interest holding company. In some embodiments, step 230 is omitted and the bank's parent company retains the general partnership interest that it obtained at step 210. In those embodiments, the bank maintains some control over the real property. As general partner, the bank may continue to be able to protect the bank's interests in how the real property is developed.

At step 235, the bank's parent company distributes the limited partnership interests and the shares in the general partnership interest holding company to the shareholders of the bank's parent company pro rata. That is, the bank's parent company distributes its partnership interests to a given shareholder in proportion to that shareholder's holdings in the bank's parent company.

In some embodiments, restrictions are placed on transfers of the limited partnership interests and the shares in the general partnership interest holding company. Such restrictions may require that any transfer of the limited partnership interests and the shares in the general partnership interest holding company be accompanied by a like transfer of the parent company's common stock. That is, the bank's parent company's shareholders may be required to treat the limited partnership interests, the shares in the general partnership interest holding company, and the shares in the bank's parent company that correspond, pro rata, to the limited partnership interests and the shares in the general partnership interest holding company as a single financial instrument. In some embodiments, the partnership's partnership agreement includes restrictions on transfer of the limited partnership interests in order to avoid having the partnership treated as a “publicly traded partnership” as defined in Section 7704 of the Internal Revenue Code of 1986, as amended. In embodiments in which the partnership interests are tied to the shares in the bank's parent company, transfer restrictions may also be placed on the parent company's shares. Such restriction may be in the form of a contract that buyers of the parent company's shares must execute before obtaining such shares.

The relevant regulatory agencies may treat the distribution of the limited partnership interests and the shares in the general partnership interest holding company (or the general partnership interest itself) as dividends in kind rather than as cash dividends. As discussed above, the limited partnership interests are essentially worth zero. Those two facts mean that the shareholders in the bank's parent company will be treated as having received a dividend in an amount equal to the fair market value of the received partnership interest, i.e., zero. The tax consequences to the shareholders of the bank's parent company are thus de minimus. Note that the shareholders in the bank's parent company do not realize any tax consequences until they sell or otherwise divest themselves of their partnership interests.

In general, the distribution of limited partnership interests by a company to its shareholders is not a transaction that requires the filing and distribution of a registration statement with the Securities and Exchange Commission (“SEC”), provided that the shareholders receive the limited partnership interests in exchange for no consideration. In some embodiments, the parent company's shareholders are not expected to receive anything other than their pro rata portion of the limited partnership interests in the partnership and are expected to receive these interests in exchange for no consideration. Therefore, in such embodiments, the distribution of these limited partnership interests may not be treated as the offering of a security requiring the filing of a registration statement with the SEC.

In some embodiments, the shareholders of the bank's parent company become limited partners in the partnership. In such embodiments, the parent company's shareholders may be required to execute a document (e.g., a joinder) evidencing that they accept the terms of the partnership's partnership agreement. Distributing the limited partnership interests to a shareholder may be conditioned upon receipt of such a document executed by the shareholder. If a particular parent company shareholder fails to execute such a document, the parent company may (i) cancel the limited partnership interest that would have gone to that shareholder, thereby increasing pro rata the limited partnership interests of all other shareholders who executed and submitted such documents, or (ii) convert the limited partnership interest to an assignment of economic interest, which would entitle the shareholder to his or her pro rata share of the economic limited partnership interest, but would not entitle them to rights as a partner. The latter approach would allow all shareholders to retain their pro rata interest even if they fail to become partners.

Other embodiments, uses, and advantages of the invention will be apparent to those skilled in the art from consideration of the specification and practice of the invention disclosed herein. The specification and drawings should be considered exemplary only, and the scope of the invention is accordingly not intended to be limited thereby.

1. A method divesting real property from a first company, the method comprising:
conveying the real property to a tax pass-through entity;
receiving, by the first company and from the tax pass-through entity, limited interest in the tax pass-through entity and general interest in the tax pass-through entity in exchange for the real property;
obtaining, by the tax pass-through entity, proceeds of a loan from a third party, wherein the tax pass-through entity pledges the real property as collateral for the loan;
conveying the loan proceeds from the tax pass-through entity to the first company;
conveying, from the first company to a parent company of the first company, limited interest in the tax pass-through entity; and
distributing, from the parent company to shareholders of the parent company, the limited and general interest in the tax pass-through entity, wherein the distributing is on a pro rata basis.

2. The method of claim 1, further comprising, before the step of distributing:
conveying, from the first company to a fourth company, general interest in the tax pass-through entity, wherein the fourth company is owned by the first company; and
conveying, from the first company to the parent company, interest in the fourth company.

3. The method of claim 1, wherein the tax pass-through entity comprises a limited partnership, further comprising the shareholders of the parent company becoming partners in the limited partnership.

4. A method of divesting real property from a first company, the method comprising:
conveying the real property to a parent company of the first company;
conveying, from the parent company to a tax pass-through entity, the real property;
receiving, by the parent company and from the tax pass-through entity, substantially all limited interest in the tax pass-through entity and substantially all general interest in the tax pass-through entity in exchange for the real property;
obtaining, by the tax pass-through entity, proceeds of a loan from a third party, wherein the tax pass-through entity pledges the real property as collateral for the loan;
conveying the proceeds from the tax pass-through entity to the parent company;
conveying the proceeds from the parent company to the first company;
conveying, from the parent company to a subsidiary of the company, substantially all general interest in the tax pass-through entity; and
distributing, from the parent company to shareholders of the parent company, substantially all limited interest in the tax pass-through entity and substantially all shares of the subsidiary, wherein the distributing is on a pro rata basis.

5. The method of claim 4, wherein the tax pass-through entity comprises a limited partnership, further comprising the shareholders of the parent company becoming partners in the limited partnership.
